(19) United States
(12) Patent Application Publication
(10) Pub. No.: US 2003/0016816 A1
(43) Pub. Date: Jan. 23, 2003

(54) Apparatus for indicating a user status

(76) Inventor: Neal N. Estroff, Alpharetta, GA (US)

Correspondence Address: Jason A. Bernstein, BERNSTEIN & ASSOCIATES, P.C., Embassy Row 400, Suite 495, 6600 Peachtree Dunwoody Road, N.E., Atlanta, GA, 30328-1649, US

(21) Appl. No.: 09/909,214

(22) Filed: Jul. 18, 2001

(51) Int. Cl. H04M 1/00; H04M 9/00

(52) U.S. Cl. 379/430

(57) ABSTRACT

A telephone headset alert mechanism which assists in the freehand operation of a telephone system. The mechanism includes a base, preferably rectangular in configuration, for pivotally mounting a weighted, unbalanced L-shaped pivot member. The L-shaped pivot member is operable between an active status mode and an inactive status mode, where the legs of the L-shaped member include indicia to identify the status of the telephone system, particularly to third parties who may approach the operator of the telephone system.

### FIELD OF THE INVENTION

The present invention relates to the field of telephone indication devices, particularly for the freehand operation of telephones, where the indication device, in the form of a pivotal flag, shows the active status of the telephone system.

### BACKGROUND OF THE INVENTION

The present invention relates to a device to indicate the active status of a headset on-line telephone system. Such a telephone system allows the user to be able to use one's hands to take messages or search through files while retaining contact with the person on the other end of the line. Typical among such users are office receptionists who may receive numerous phone calls to be passed on to the desired employees. To assist these phone operators, “hands free” telephone headsets were developed to operate in conjunctions with conventional telephone base units. Such headsets include a curved boom which positions a small microphone in close proximity to the front of the user's mouth. An earphone is positioned at the other end of the boom so as to be adjacent to the user's ear. Finally, a headband suspends the boom and earphone adjacent the user's face. Though a receptionist may be a common use of such a telephone system, it is now becoming more common for individuals to require such system to ensure the freedom to use one's hands in leafing through various papers, or to search and operate a computer while continuing to talk to the person at the other end of the phone. Unfortunately, absent some clear device or mechanism to indicate the active status of the system, a third party approaching the user would not always know that the user is on the phone, and may inadvertently interrupt the user. This can be embarrassing to the third party and disconcerting to the user.

Recognizing the importance of providing some apparent device or mechanism that will show third parties that the telephone system is active, particularly where there may be a pause in the phone conversation, the prior art developed a number of devices that might be used in conjunction with the telephone system. Such prior art devices are reflected in the following U.S. patents:

a) U.S. Pat. No. 3,819,873, to Stockton et al., discloses a telephone call indicator comprising an electronic box that displays an illuminated light when a telephone call has arrived. More specifically, the device thereof includes an induction pickup coil for receiving a signal from a telephone set, means for amplifying said signal, a normally open latching switch in circuit with a visual signal and a power supply, and means for applying the amplified signal for closing the latching switch to effect energizing of the visual signal, and a manually operated switch for resetting the device.

b) U.S. Pat. No. 4,544,808, to Milne et al., is directed to an indicator for use with a multi-line telephone system, and includes a series of push buttons which cause a display to change color or shade to indicate that a user is on a line to displays the status of both a local and called telephone set. The status indicator preferably comprises a first indicator enclosed within a second for displaying by a shade or color the status of a called line, and a second indicator at least partly surrounding the first, whereby a party observing the indicator obtains simultaneous indication of the status of the calling and the called lines. More precisely, the first indicator is a circle, enclosed within the second indicator which is a square, both being elements of a liquid crystal display. Each square indicator can be located next to a line access pushbutton with which it is associated.

c) U.S. Pat. No. 5,210,791, to Krasik, teaches a telephone headset on-line indicator that uses a light emitting diode located on a boom of a headset to indicate that the user is on-line with another telephone. Circuits are described for use with use with conventional telephones, electronic telephones and PBX telephone base units.

d) U.S. Pat. No. 5,608,794, to Larson, relates to an indicator lamp, integrated with the boom or microphone which visually lights up when a caller is on the telephone, that identifies the status of telephone calls both transmitted and received from a hands-free telephone headset. The indicator lamp is either automatically activated by a signal from a telephone line or manually activated by a switch. Manual activation provides an additional means for the operator to prevent interruptions regardless of telephone status. The indicator lamp is located at various locations on the headset next to the mouthpiece or, alternatively, along the entire length of the headset arm.

e) U.S. Pat. No. 6,014,942, to Perka et al., discloses a signal device for a telephone workstation that includes a plurality of visually different flags in a mounting frame secured to the top of a cubicle wall forming a part of a workstation. As a result, the status of the workstation user can be visually determined. The flags are normally in a generally horizontal position in the mounting frame, and may be in a recess in the top of the cubicle wall. A flag corresponding to the desired message is raised from the mounting frame, so that the flag is visible above the top of the cubicle wall.

While the foregoing prior art reveals a number of complex systems for providing a visible indicator to users of a headset telephone system, they represent unnecessary cost to the user, when a simpler device may do a comparable or better job of alerting others that the headset telephone system is in use. The indicator mechanism of the present invention accomplishes the need to provide a visible alert by the use of a color or indicia coded pivotal flag operable in first and second modes, where the first mode may indicate on-line use, and the second mode a non-use. The manner by which this invention provides a visual alert will become more apparent in the description which follows, particularly when read in conjunction with the accompanying drawings.

### SUMMARY OF THE INVENTION

This invention is directed to a visual alert mechanism for use with operators of a “hands free” telephone system, where such mechanism becomes an alerting system for those approaching the user but not realizing that the operator may be currently engaged in a telephone conversation. The mechanism hereof, which may consist of a plurality of parts to be preassembled, comprises a base mounting an unbalanced pivotal member. The base comprises an essentially elongated member for resting on a table top or desk, such as at a workstation, in close proximity to the headphone. The base may include a lateral upraised portion defining a lateral opening for receiving a pivot pin. For pivotal mounting to said base is an unbalanced, L-shaped pivoting member, where one leg thereof is longer and heavier than the second leg. Further, the respective free ends of the two legs may include a specific color code or indicia that reflect the operating mode of the mechanism, and hence whether the operator is “on-line” or “off-line”. By way of example, if the operator or user wishes to activate the alert mechanism, such as when on the phone, he can place the conventional phone set or other weight onto the short leg to position same contiguous to the base. This action will pivot the longer leg to a vertical position, where the free end may be colored red, or contain indicia, such as “on-line”, that easily alerts any third party to the fact that the operator in on the phone. When the call is terminated, the phone set or weight is removed and the L-shaped pivotal member, through gravity, pivots to bring the longer leg into contact with the base. Concurrently, the shorter leg rises to a vertical position, where the free end thereof may reflect a different color, i.e., green, or indicia, such as “off-line”, to indicate the operator is not occupied with a phone call.

Accordingly, a feature of the present invention is to provide a simple, yet effective mechanism for use by a “hands free” operator who wishes to alert others to the fact that the operator is preoccupied in a phone conversation.

A further feature hereof lies in the use of an L-shaped pivotal member that pivots between two positions to define, respectively, an “on-line” mode, and an “off-line” mode.

These and other features will become more apparent in the specification and accompanying drawings which follow.

### BRIEF DESCRIPTION OF DRAWINGS

FIG. 1 is an exploded side view, partially sectioned, illustrating the telephone headset alert system of this invention.

FIG. 2 is an end view of the components shown in FIG. 1.

FIG. 3 is a partially sectioned view of the assembled components of FIGS. 1 and 2, showing the “off-line” operating mode for the telephone headset alert mechanism of the invention.

FIG. 4 is a partially sectioned view of the assembled components of FIGS. 1 and 2, but showing the “on-line” mode for the mechanism hereof.

FIG. 5 is a side view of the assembled components of FIG. 4.

FIG. 6 is a side view, similar to FIG. 4, showing further plural table supporting legs for the base component of the invention, and a conventional phone headset resting on and maintaining the pivoted position of the pivotal component of the invention.

### DETAILED DESCRIPTION OF PREFERRED EMBODIMENT

This invention relates to a telephone headset alert mechanism of the type that may be used by a “hands-off” phone system to allow the operator to perform other tasks when on the phone, while alerting others to the active status of the phone system. For instance, others within proximity to the operator may not know whether the operator is currently talking or listening to someone on the phone system. Thus, a phone call may be inadvertently interrupted by direct verbal communication. The operator must then either interrupt the person attempting to communicate directly or interrupt the telephone communication, neither of which is good social or business practice. The present invention, in a simple and effective manner, ensures the operator that such action can be avoided. The present invention can also include indicia on the flag portion, such as, but not limited to, “do not disturb”, “off limits”, or the like. The present invention can also be used in classrooms, recording studios, libraries, during dictation, or the like where quiet is important and alerting someone as to the need for quiet is important. The manner by which this can be achieved will now be described with regard to the several Figures, where like reference numerals represent like components or features throughout the various views.

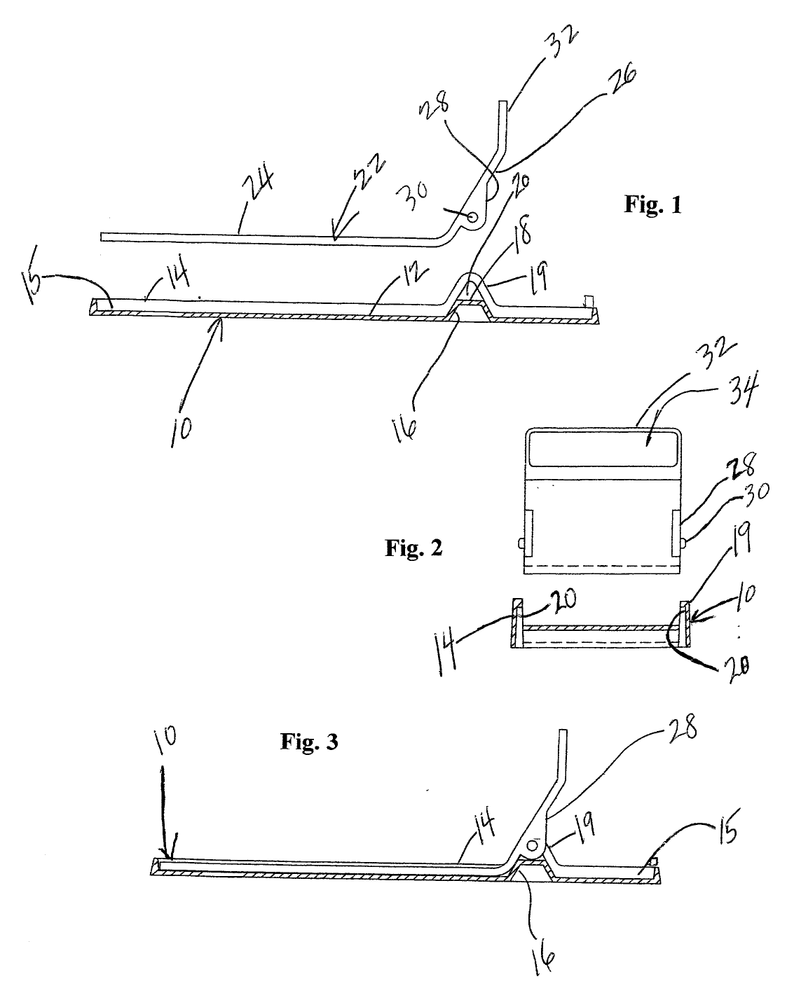

Turning first to FIGS. 1 and 2, the mechanism of this invention comprises a base 10 to be supported on a table top, desk, or work station, as known in the art, having a floor 12, and peripheral side walls 14 to define a recess 15. Additionally, the floor 12 includes a raised portion 16 having a top wall 18 that cooperates with a complementary, raised side wall portion 19 to define an opening or recess 20.

For pivotal mounting to the base 10 is an unbalanced, essentially L-shaped member 22, the upper component in FIG. 1. The L-shaped member 22 comprises a first long leg 24 and a two sectioned, second short leg 26 offset mounting a pair of opposed pivot heads 28, each having an outwardly extending pivot pin 30, note the upper component of FIG. 2. As best seen in FIGS. 2 and 3, the pair of pivot pins 30 are positioned within the corresponding pair of openings or recesses 20. In this manner the L-shaped member 22 is fixed for rotative movement relative to the base 10.

FIG. 3 illustrates the “off-line” mode for the mechanism of this invention, with the short leg 26 projecting upward, and the longer leg 24 lying within the recess 15. The free end 32 of the short leg includes a colored section or flag 34, “green”, for example, or descriptive indicia, such as “off-line” as a quick and easy way of alerting others that the operator is free.

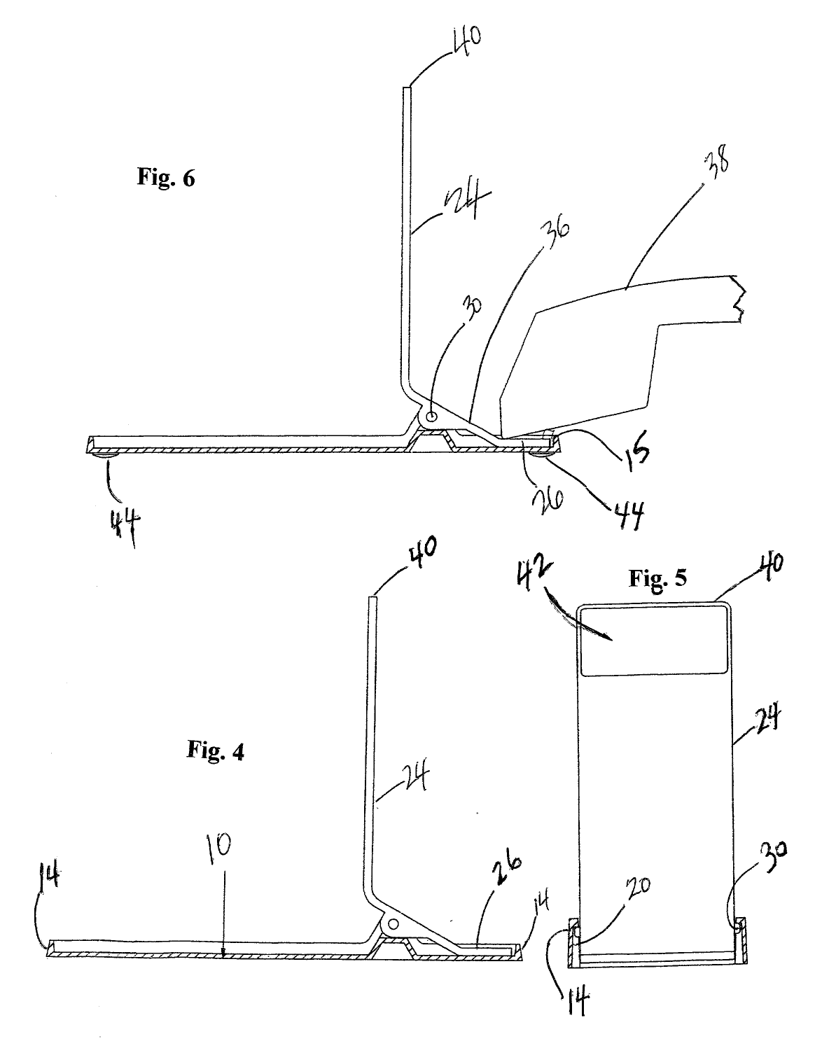

FIGS. 4 through 6 illustrate the “on-line” mode for the mechanism of the present invention. In the operating mode the longer leg 24 projects upwardly with the shorter leg 26 resting in the base recess 15. With the pivot pins 30 offset within the short leg section 36, the weight of the longer leg 24 is such, that without restraint, will cause the L-shaped pivoting member 22 to pivot to the position of FIG. 3. As a consequence, the operator may ensure the longer leg is maintained in an upper position by placing the conventional phone headset 38, or other weighted object, on the shorter leg 26, see FIG. 6. Conversely, by removing the headset or weighted object, the longer leg 24, through gravity, will return to the position of FIG. 3. In any case, in the fashion of the shorter leg 26, the free end 40 of the longer leg is provided with a colored flag, i.e., “red” 42, or indicia, such as “on-line”. Thus, anyone approaching the operator may readily see whether the appropriate colored flag or indicia is showing, and whether the operator is free to talk.

As a final feature of the mechanism of this invention, plural feet 44, in the form of rounded stick-on elements, may be attached along the four comers of the base 10, see FIG. 6.

It is recognized that changes, variations and modifications may be made to the telephone headset alerting mechanism of this invention, especially by those skilled in the art, without departing from the spirit and scope thereof. Accordingly, no limitation is intended to be imposed thereon except as set forth in the accompanying claims. All patents, applications and publications referred to herein are incorporated by reference.

Claimed is:

1. A telephone headset alert mechanism to assist in the freehand operation of a telephone system, where said mechanism provides a visual indication of the use of the telephone system, said mechanism comprising:
a. a base having an upstanding peripheral wall with opposing side walls including means for pivotally mounting an L-shaped pivotal member, where said peripheral wall defines a recess within said base;
b. a weighted, unbalanced L-shaped pivotal member comprising a first long leg and a second short leg of a weight less than said first long leg, where said short leg includes a pair of pivot pins for operative engagement with said means; and;
c. each said leg having a free end featuring different visual indicia to indicate the status of said telephone system, where an active status mode is indicated by said long leg in an upright position, and an inactive mode is indicated by said short leg in an upright position.

2. The telephone headset alert mechanism of claim 1, wherein said long leg is seated within said recess in said inactive mode.

3. The telephone headset alert mechanism of claim 1, wherein said short leg is seated within said recess in said active mode.

4. The telephone headset alert mechanism of claim 1, wherein said indicia is selected from the group consisting of colors and written copy.

5. The telephone headset alert mechanism of claim 1, wherein said base includes a raised transverse section aligned with said pivoting means, and said raised transverse section cooperates with said means to pivotally mount said L-shaped pivotal member.

6. The telephone headset alert mechanism of claim 1, wherein said short leg includes two angularly oriented leg segments, and said pivot pins project laterally from one of said leg segments.

7. The telephone headset alert mechanism of claim 1, including plural feet extending below said base for supporting said base on an underlying surface.

8. A telephone headset alert mechanism to assist in the freehand operation of a telephone system, where said mechanism provides a visual indication of the use of the telephone system, said mechanism comprising:
a. a generally rectangular base having an upstanding peripheral wall with opposing side walls including recess means for pivotally mounting an L-shaped pivotal member, where said peripheral wall defines a recess within said base;
b. a weighted, unbalanced L-shaped pivotal member movable between an active status mode and an inactive status mode, said member comprising a first long leg and a second short leg of a weight less than said first long leg, where said short leg includes a pair of pivot pins for operative engagement with said recess means; and,
c. each said leg having a free end featuring different visual indicia selected from the group consisting of colors and written copy to indicate the status of said telephone system, where said active status mode is indicated by said long leg in an upright position, and said inactive status mode is indicated by said short leg in an upright position.

9. The telephone headset alert mechanism of claim 8, wherein said base includes a raised transverse section aligned with said pivoting means, and said raised transverse section cooperates with said means to pivotally mount said L-shaped pivotal member.

10. The telephone headset alert mechanism of claim 8, wherein said short leg includes two angularly oriented leg segments, and said pivot pins project laterally from one of said leg segments.

11. The telephone headset alert mechanism of claim 8, including plural feet extending below said base for supporting said base on an underlying surface.
